(19) United States
(12) Patent Application Publication
(10) Pub. No.: US 2005/0118920 A1
(43) Pub. Date: Jun. 2, 2005

(54) Method for the production of a microstructure comprising a vacuum cavity and a microstructure

(75) Inventors: Pierre-Olivier Lefort, Valence (FR); Isabelle Thomas, Valence (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: Thales

(21) Appl. No.: 10/510,385

(22) PCT Filed: Apr. 1, 2003
(86) PCT No.: PCT/FR03/01012

(30) Foreign Application Priority Data
Apr. 12, 2002 (FR) 0204628

(51) Int. Cl. H01J 9/00

(52) U.S. Cl. 445/24

(57) ABSTRACT

The invention relates to a process for fabricating a microstructure containing a vacuum cavity. The invention includes producing, from a first silicon wafer, a porous silicon region intended to form, completely or partly, one wall of the cavity and capable of absorbing residual gases in the cavity and joins the first silicon wafer to a second wafer, so as to produce the cavity.

The subject of the invention is a process for fabricating a microstructure containing a vacuum cavity.

The subject of the invention is also a microstructure containing a vacuum cavity.

The field of the invention is that of components comprising a microstructure containing an internal cavity placed under vacuum. Among such components, mention may be made of sensors for detecting various physical parameters, such as pressure sensors, acceleration sensors or angular velocity sensors, such as gyrometers.

The function of the cavity may be to:
form a vacuum reference cavity for pressure sensors;
allow the vacuum packaging of sensor elements such as resonators widely used to produce resonant pressure sensors, resonant accelerometers or VBAs (vibrating beam accelerometers), vibrating gyrometers or electromechanical filters.

The performance characteristics of such components, and especially precision and stability depend in particular on the vacuum achieved in the cavity, that is to say the internal pressure of the cavity: good performance characteristics are obtained when these components operate at very low pressure, typically less than 0.01 mbar.

For example in the case of components using resonators, it is necessary to ensure a low enough pressure level around the resonator between 0.0001 and 0.01 mbar, in order to avoid introducing damping into the movements of the resonator.

In the case of accelerometers, operation at these very low pressures also prevents, although the cavity is placed in a vacuum, the residual gas in the cavity from disturbing the operation by modifying the reference mass value of the accelerometer by an absorption/desorption effect of the molecules on the surface of the mass.

Various types of technology for evacuating the cavity may be used.

A first technology consists in producing a metal or ceramic package in which the microstructure is placed, the cavity of which is left open. The package is then evacuated by pumping/outgasing the cavity by means of a pumping tube (for example made of glass) for several days; the package is then sealed by a tube tipping-off operation, that is to say by pinching off the tube. The major drawbacks of this technology are cost and the size of the package.

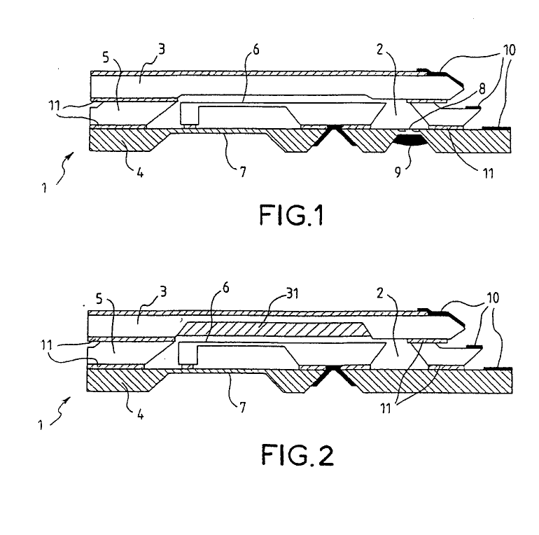

A second technology, which relates only to the microstructure, consists in providing a small hole in a dedicated region of the cavity. FIG. 1 shows an example of such a microstructure 1, the cavity 2 of which is bounded by three wafers, an upper wafer 3, a lower wafer 4 and an intermediate wafer 5; a resonator 6 housed in the cavity 2 is used to measure the pressure by means of a membrane 7 to which it is connected. The microstructure conventionally has contact pads 10 and optionally insulating layers 11. After pumping/outgasing the cavity 2, the hole 8 is sealed off by fusion of a suitable material 9, such as a glass or a metal alloy, for example Sn/Pb.

The sealing-off operation is carried out microstructure by microstructure, and requires preparation of the surfaces of the hole in order to permit the sealing material to adhere to these surfaces, which represents a first drawback of an industrial kind.

There is also a technical drawback associated with the presence of a sealing material that differs from the base material of these microstructures, generally silicon or even quartz. This inhomogeneity between the materials introduces high stresses on the walls of the hole because of the differential expansion between these materials: for example, the expansion of silicon is from 2 to 3 ppm/° C. whereas that of an Sn/Pb alloy exceeds 15 ppm/° C. The stresses generated may then be transferred to the active part of the microstructure and degrade the measurement performance.

The above technologies apply when the cavity has been formed.

A third technology, which also relates only to the microstructure, comes into play during production of the cavity: it consists in joining together, under vacuum, wafers that define the cavity. The joining operation is carried out by bonding, namely glass/silicon anodic bonding when one wafer is made of glass and the other made of silicon, and silicon/silicon bonding when both wafers are made of silicon.

In the case of glass/silicon bonding, the bonding process causes oxygen to be produced by decomposition of the glass used for this type of bonding; this may be the glass of the wafer itself or a glass used for the bonding, and identical to the glass of the wafer. Such oxygen production results in an internal pressure of 1 to 10 mbar, which is much too high for the intended components.

Silicon/silicon bonding makes it possible to produce a homogeneous microstructure of excellent mechanical quality and hermeticity. A physico-chemical treatment of the substrates is carried out in order to place the surfaces to be bonded in a particular chemical state. Moreover, the bonding process must be supplemented with a heat treatment at high temperature, typically 1000° C., in order to achieve optimum properties of the join. To avoid a substantial rise in pressure caused by the heat treatment, a prior operation of outgasing the walls of the cavity ought to be carried out; however, this outgasing operation would then destroy the chemical state of the surfaces to be bonded. This technology therefore does not make it possible to obtain a low pressure inside the cavity.

Another technology consists in providing in the cavity an additional location intended to accommodate a getter material that can absorb the residual gases in the cavity. It supplements, for example, the third technology. This additional location increases the volume of the microstructure. Moreover, it requires the getter material to be fixed to one of the walls of the cavity, which introduces an additional step in the fabrication process. Finally, the operation of fixing the getter to the wall must be compatible with an annealing operation, when such an operation is necessary, via a heat treatment such as that described in the case of the previous technology, thereby introducing an additional constraint.

One important object of the invention is therefore to propose a process for fabricating a microstructure containing a vacuum cavity that does not have the abovementioned drawbacks.

To achieve this object, the invention proposes a process for fabricating a microstructure containing a vacuum cavity, mainly characterized in that it comprises the following steps that consist in:
a) producing, in the thickness of a first silicon wafer, a porous silicon region intended to form, completely or partly, one wall of the cavity and capable of absorbing residual gases in the cavity;
b) joining the first silicon wafer to a second wafer, so as to produce the cavity.

According to one feature of the invention, the joining operation of step b) is carried out under vacuum, especially by bonding at ambient temperature.

The process according to the invention, which consists in directly evacuating the cavity during assembly of the wafers that define the cavity, is thus based on the use of a material that can absorb the residual gases in the cavity. This material is formed from one of the wafers and therefore has the same mechanical properties as the rest of the microstructure.

The subject of the invention is also a process for the collective fabrication of microstructures.

The invention also relates to a microstructure containing a vacuum cavity, characterized in that it comprises at least two wafers that contribute to defining the cavity, one of said wafers being made of silicon and including a porous silicon region capable of absorbing residual gases in the cavity, the region being produced in the thickness of said silicon wafer.

Finally, the invention relates to a sensor having such a microstructure.

Other features and advantages of the invention will become apparent on reading the detailed description that follows, given by way of nonlimiting example and with reference to the appended drawings in which:

FIG. 1, already described, shows schematically a microstructure used for a pressure sensor;

FIG. 2 shows schematically a microstructure according to the invention, again used for a pressure sensor.

The process according to the invention will now be described in greater detail by taking as example the fabrication of a microstructure for a pressure sensor of the same type as that of FIG. 1, the cavity of which is bounded by three wafers. The microstructure obtained is shown in FIG. 2; the same elements are denoted by the same references.

One of the wafers, in this case the upper wafer 3, is made of silicon, preferably single-crystal silicon; according to a first step of the invention, a porous silicon region 31 is produced from this wafer 3, in the thickness of the latter.

This porous silicon region is in general produced using methods known to those skilled in the art, by electrochemical etching in a solution based on hydrofluoric acid to which H₂SO₄ or HNO₃ or ethanol has been added. Depending on the method used, the porous silicon obtained has a percentage void content of 30 to 60%, with pores from 20 to 40 Angstroms in the case of an n-or p⁻-type silicon substrate, or pores of 0.1 μm in the case of a p⁺-type substrate. These pores are as many microcavities, generating a very large absorption surface compared with the initial surface area of the substrate. This porous silicon region can be produced over very substantial thicknesses, typically between 100 and 200 μm, the wafer 3 conventionally having a thickness of between 250 and 600 μm; it retains the same volume and the same thermal expansion coefficient as single-crystal silicon. The silicon wafer that includes this porous silicon region thus remains homogeneous from the thermal standpoint.

This region fabricated from the wafer itself is thus rendered more fully integral with the upper wafer than if it had been added to this wafer and fixed thereto; it consequently exhibits better resistance to the mechanical vibrations to which the microstructure may be subjected in the course of operation. However, according to a variant of the invention, the region 31 is made not in part of the thickness of the wafer 3, as indicated above, but right through the entire thickness of the upper wafer 3 to which another silicon wafer, for example a single-crystal silicon wafer, is then joined, thus forming a cover for the porous region.

More generally, the porous region can be produced on any surface in contact with the cavity.

According to a variant of the invention, another material that can also absorb the residual gases in the cavity is deposited by spraying on the porous silicon region, in proportions allowing the pores of the porous silicon to be covered without however blocking them. The porous silicon region thus impregnated is used in this case solely to increase the absorption surface area in the cavity. This other material, chosen to be more active than porous silicon, may be titanium.

During a second step, the wafers 3, 4 and 5 undergo a physico-chemical preparation of their surface for the purpose of joining them together—the surfaces are, for example, prepared by means of concentrated nitric acid solution which causes OH radicals to be generated on the surface of the wafers.

The wafers 3, 4 and 5 are then outgased; the outgasing is however limited in order not to destroy the physico-chemical state of the surfaces that was obtained after the previous step.

The wafers are then joined together under vacuum, by bonding at ambient temperature, or possibly by brazing at temperatures varying up to about 400° C. Firstly, the lower wafer is, for example, joined to the intermediate wafer and the resonator fastened to the lower wafer; the upper wafer is then joined to the intermediate wafer. The intermediate wafer, upper wafer and resonator may also be made of silicon, or even glass or a combination of silicon and glass.

The microstructure thus obtained is subjected to a high-temperature annealing operation (between 400 and 1000° C.) in order to strengthen the bond. Porous silicon has the advantage of being compatible with these temperatures. During this annealing phase, the internal surfaces undergo strong outgasing, typically resulting in an increase in pressure from 10 to 100 mbar in the absence of porous silicon. The presence of a large surface area of porous silicon makes it possible, however, during this annealing phase to absorb the molecules responsible for the increase in pressure and to bring the cavity back to a high vacuum, of 0.01 millibar or less.

During this annealing, there also occurs an activation of the porous silicon that generally takes place at temperatures of around 400° C. This activation allows the surface of the porous silicon to be cleaned by desorption of the H molecules present after production of the porous silicon layer.

Thereafter, during operation of the microstructure, outgasing also occurs, to a lesser extent than that occurring for example during the annealing phase, but nevertheless of nonzero extent. The amount of porous silicon is in general sufficient to absorb the molecules resulting from this slight outgasing. As a result, the stability and reliability of the xmicrostructure during operation are improved. The lifetime of such a microstructure is commonly 20 years.

In the microstructure example described, the cavity is bounded by three wafers. In another example, the cavity may be bounded by two wafers, one or both of which have an indentation.

A microstructure for a pressure sensor has been described, but the process according to the invention makes it possible, of course, to fabricate microstructures for high-precision sensors that in general make use of the resonant elements, or to fabricate microstructures for devices other than sensors.

This fabrication process furthermore makes it possible to produce microstructures, such as those described, collectively by full-wafer assembly. This is because no hole-sealing-off operation needs to be carried out microstructure by microstructure.

1. A process of fabricating a microstructure having a vacuum cavity, comprising the following steps:
a) producing, in the thickness of a first silicon wafer, a porous silicon region intended to format least a part of one wall of the cavity and capable of absorbing residual gases in the cavity; and
b) joining the first silicon wafer to a second wafer, so as to produce the cavity.

2. The process as claimed in claim 1, wherein step a) furthermore includes a step of impregnating the porous silicon region with another material that can also absorb residual gases in the cavity.

3. The process as claimed in claim 1, wherein when the cavity has a predetermined height, the joining operation of step b) is carried out by means of an intermediate wafer whose thickness contributes to the height of the cavity.

4. The process as claimed in claim 1, wherein prior to step b), the process includes a step of carrying out a physico-chemical preparation of the surfaces of the wafers used in step b).

5. The process as claimed in claim 1, wherein prior to step b), the process includes a step of outgasing the wafers used in step b).

6. The process as claimed in claim 1, wherein the joining operation of step b) is carried out under vacuum.

7. The process as claimed in claim 6, wherein the joining operation is carried out by bonding at ambient temperature.

8. The process as claimed in claim 7, wherein the process includes a step c) of annealing, at between 400 and 1000° C., the microstructure obtained after step b) so as to strengthen the bond.

9. The process as claimed in claim 2, wherein the other material that can also absorb the residual gases in the cavity consists of titanium.

10. The process as claimed in claim 1, wherein the second wafer and/or the intermediate wafer are made of silicon or glass.

11. The process as claimed in claim 1, wherein the process is applied collectively to several micro structures.

12. A microstructure having a vacuum cavity, comprising:
at least two wafers that contribute to bounding the cavity, the first wafer of said two wafers, is made of silicon and includes a porous silicon region capable of absorbing residual gases in the cavity, the region being produced in the thickness of said silicon wafer.

13. The microstructure as claimed in claim 12, wherein the porous silicon region is impregnated with another material that can also absorb residual gases in the cavity.

14. The microstructure as claimed in claim 13, wherein the other material that can also absorb residual gases in the cavity is titanium.

15. The microstructure as claimed in claim 12, wherein the wafers other than the first wafer are made of silicon or glass, or a combination of silicon and glass.

16. The microstructure as claimed in claim 12, wherein said microstructure includes a resonator housed in the cavity.

17. A sensor having a microstructure as claimed in claim 12.

18. The sensor as claimed in claim 17, wherein the sensor is a resonant pressure sensor or a resonator accelerometer or a vibrating gyroscope or an electromechanical filter.
